(19) United States
(12) Patent Application Publication
(10) Pub. No.: US 2015/0117639 A1
(43) Pub. Date: Apr. 30, 2015

(54) SECURE AND PRIVACY FRIENDLY DATA ENCRYPTION

(71) Applicant: IdentaChip, LLC, Issaquah, WA (US)

(72) Inventor: Dannie Gerrit Feekes, El Dorado Hills, CA (US)

(21) Appl. No.: 14/514,373

(22) Filed: Oct. 14, 2014

Related U.S. Application Data
(60) Provisional application No. 61/895,932, filed on Oct. 25, 2013.

(51) Int. Cl. H04L 9/16

(52) U.S. Cl. CPC H04L 9/16
USPC 380/28

(57) ABSTRACT

In one aspect, the present disclosure provide an encryption circuit that performs a method for establishing a secure communication channel. In this regard, the method includes receiving a public encryption key from a transmitting device. In response, a receiving device sends to the transmitting device an index which references a table entry identifying at least one variable in an encryption scheme. Then, the method encrypts data in a communication session with the transmitting device using a first encryption algorithm. The receiving device then receives an indicator to change encryption algorithms. In response, a second encryption algorithm associated with the encryption scheme is identified and the method then encrypts data in a communication session with the transmitting device using the second encryption algorithm.

### CROSS-REFERENCE TO RELATED APPLICATIONS

This application claims the benefit of U.S. Provisional Patent Application No. 61/895,932 filed on Oct. 14, 2013 which is herein incorporated by reference.

### BACKGROUND

The advent of the information age has created new challenges in the ability to protect the privacy and security of information. There are now vast numbers of ways in which people can be connected online and this increased connectivity is one of the defining information technology trends in the early twenty-first century. By providing various institutions and people with access to shared and/or often physical dispersed computing resources, communication networks can simultaneously offer increased flexibility, reduced cost, and/or access to a wider array of services. However, increased connectivity and reliance on networks has also created a new set of security and privacy challenges. Many types of communications transmitted between devices can be vulnerable to interception. To prevent such interception or at least mitigate its' effects, there is an overwhelming reliance on various forms of encryption. Certain standardized and widely deployed encryption schemes, such as RSA (Rivest, Shamir, and Adleman), have previously been thought to provide sufficient security in network communications.

Recently, it has been widely reported that certain institutions and governmental actors have circumvented or ‘cracked’ much of the commonly accepted encryption schemes; the systems that guard global network communications including commerce and banking. This reality has potentially compromised massive amounts of network communications. These recent developments have exposed a fundamental vulnerability to any broadly accepted encryption scheme. Black hat agents or others attempting to compromise communications may need only to focus on cracking the encryption scheme that is known to be employed or standard for the target application. The efforts of these black hat actors may have been made easier by the deliberate weakening of certain standardized encryption schemes. If RSA encryption is a near universal standard that is accepted by banks for financial transactions, for example, than black hat agents may only need to focus on cracking this singular encryption scheme. The standardization and near universal deployment of certain encryption schemes has made the effort in cracking communications much simpler than a scenario where a varied and/dynamic encryption scheme is employed.

In the most basic sense, existing encryption schemes are built upon a vectored mathematical implementation that can be represented as follows:

f(x,y)=Qi+Rj

This vector function takes at least two inputs or keys and generates a minimum of a two component vectored results. One of these vectors or keys is typically used to encrypt the data that is transmitted to a receiving agent (RA). Data blocks are processed by the cryptographic algorithm based on one of these keys. In most implementations, the RA has knowledge of both keys (hereinafter referred to as the public (x) and private key (y)). The RA transmits the public key, which is externally visible, to the transmitting agent (TA). In this implementation, the TA is only in possession of the public key which is sufficient as an input to a function that generates one portion of the vectored results in the function (y)=Rj. The RSA encryption algorithm, for the purposes of this example, utilizes integer factorization and the property that every integer is a product of a prime number. In other words, the algorithm exploits a function that does not have a complementarity to encrypt the data. The public key consists of two numbers, namely (1) η, the product of two random prime numbers (ρ,σ), and (2) a random odd number ξ which is less than and not divisible by (ρ−1)(σ−1). In this regard, the TA encrypts the data λ in accordance with the following function:

f(x,Y)=f(η,ξ)=Qi+Rj=(λ̂ξ)/η

This function has a two component results; namely: (1) the quotient Q, and (2) the remainder R. The remainder is used to encrypt the data that is transmitted to the RA. An entity that observes the public key and encrypted data only knows that λ̂ξ/η equals some number with a remainder of R. When dealing with large numbers, candidates for Q are overwhelming large to solve. Until recently, this scheme has probably provided sufficiently secure encryption. It has previously been the case that one could only realistically solve for Q when there was access to the private key. Recent events and increased sophistication of black hat agents suggest that this assumption is no longer valid. With the reliance on network communications for increasingly sensitive tasks, there needs to be more robust and privacy-friendly ways of securing data. In this regard, it should be understood that there are an infinite number of mathematical functions that can perform data encryption based on the fundamental principles used by RSA and other similar encryption algorithms.

### SUMMARY

This summary is provided to introduce a selection of concepts in a simplified form that are further described below in the Description. This summary is not intended to identify key features of the claimed subject matter, nor is it intended to be used as an aid in determining the scope of the claimed subject matter.

The present disclosure is generally directed to systems, methods, and devices operable to secure communications in a way that better addresses the security needs of an increasingly connected and mobile society. In one embodiment, aspects of the present disclosure provide a encryption circuit that performs a method for establishing a secure communication channel. In this regard, the method includes receiving a public encryption key from a transmitting device. In response, a receiving device sends to the transmitting device an index which references a table entry identifying at least one variable in an encryption scheme. Then, the method encrypts data in a communication session with the transmitting device using a first encryption algorithm. The receiving device then receives an indicator to change encryption algorithms. In response, a second encryption algorithm associated with the encryption scheme is identified and the method then encrypts data in a communication session with the transmitting device using the second encryption algorithm.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 is a block diagram depicting an exemplary networking environment where described embodiments of the disclosed subject matter can be implemented;

FIG. 2 is a block diagram depicting exemplary devices and components that may be used to illustrate aspects of the present disclosure;

FIG. 3 is a flow diagram illustrating a method configured to perform a secure exchange of sensitive data in accordance with embodiments of the present disclosure;

FIGS. 4A-B are block diagrams depicting an exemplary networking environment where described embodiments of the disclosed subject matter can be implemented; and

FIG. 5 is a block diagram depicting exemplary devices and components that may be used to illustrate aspects of the present disclosure.

### DESCRIPTION

The description set forth below in connection with the appended drawings where like numerals reference like elements is intended as a description of various embodiments of the disclosed subject matter and is not intended to represent the only embodiments. Each embodiment described herein is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

Generally described, the present disclosure is directed to improved data security and is particularly applicable to securing network communications, although it is by no means limited to such use. A multifaceted scheme is provided that fundamentally increases the implementation complexity needed to compromise network communications. In one aspect, the present disclosure provides a novel approach to the generation and transmission of sensitive data such as encryption keys that prevents interception by any intervening observers. As part of a set up or authentication flow, at least two distinct channels can be employed to separately communicate encryption keys and other sensitive data between endpoint devices. By leveraging separate communication channels, the present disclosure effectively hides encryption keys which serve as the basis of the encryption algorithm from any intervening observers. A black hat agent would be required to observe and associate data intercepted from separate and unrelated data streams sent on different transmission mediums to compromise a communication.

In another aspect, the present disclosure provides a variable and/or dynamic encryption scheme that prevents observers from deciphering any observed ciphertext. Any number of different encryption algorithms can be employed in a communication session and these algorithms can be changed dynamically, at any time. In addition, variables that define the encryption scheme provided by the present disclosure can be specific to a particular user and/or device. Instead of relying solely on an encryption algorithm that is ubiquitous and whose implementation details are well-known, the manner in which data is encrypted varies and is dependent on unique attributes of a user. By way of example, a user's biometric attribute or a device signature can be used as the basis to select and/or change how and which encryption algorithms are employed. A black hat agent could not rely on the fact that a single encryption algorithm is being employed. Instead, the present disclosure provides a way for data to be encrypted and transmitted in a manner that is specific to a particular user and/or device.

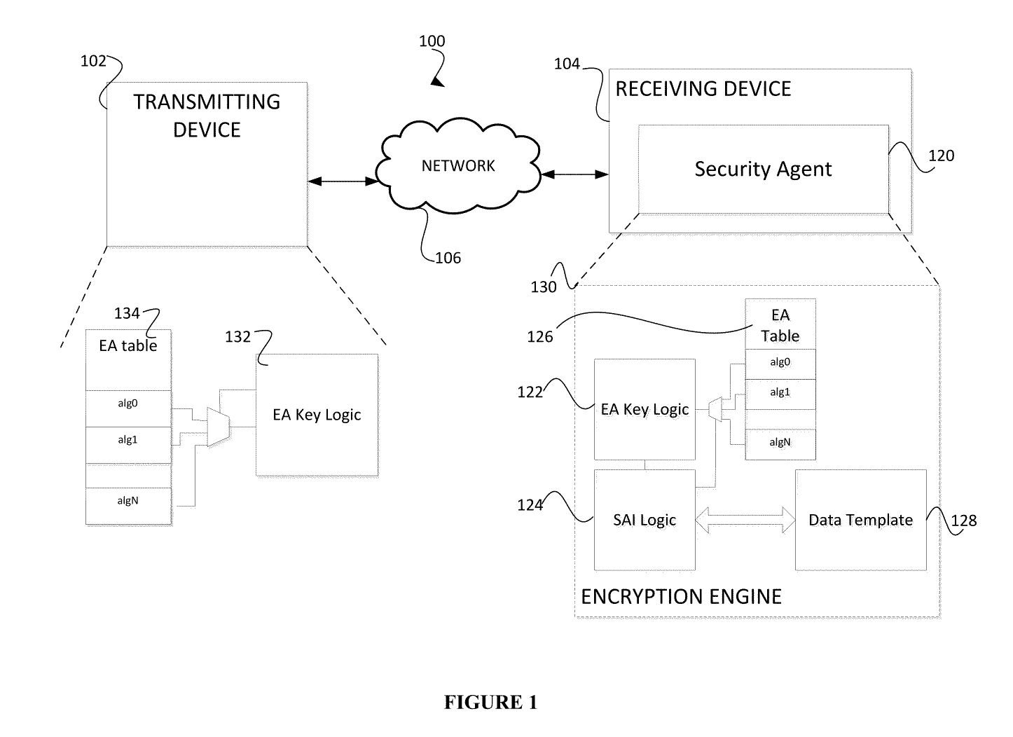

Now with reference to FIG. 1, a Networking Environment 100 suitable for illustrating various aspects of the present disclosure will be described. In the embodiment shown in FIG. 1, the Networking Environment 100 includes a Transmitting Device 102 and a Receiving Device 104 that are communicatively connected via the Network 106. In one aspect, the present disclosure is directed to securing communications between network connected devices such as the Transmitting Device 102 and a Receiving Device 104 in a way that has a number of advantages over existing systems. In this regard, the devices 102-104 may be any network connected device including, but not limited to, mobile phones, tablet computers, laptop computers, desktop computers, servers, mainframes, network appliances, Internet-of-Things (IOT) devices, M2M devices, wearable computers, embedded devices, or any other device able to transmit data over a network connection.

As shown in FIG. 1, the Receiving Device 104 may include a Security Agent 120 that is responsible for the generation, storage and transmission of sensitive data (such as encryption keys). General purpose platforms such Windows, Android, iOS, are particularly hospitable to malware. These platforms support an architecture convenient to developers but which also allows hackers to exploit weak points or vulnerabilities in software security and obtain unauthorized access. Aspects of the present disclosure are configured to eliminate certain vulnerabilities in these platforms and securely generate, store, and/or transmit sensitive data utilizing technology that provides a segregated secure environment. In this regard, the Security Agent 120 may be an SOC security agent that has the primary function of providing security and encryption services to all devices that share a common memory fabric such as so-called TrustZone technology available from ARM Holdings. Other examples of technologies for providing the Security Agent 120 may be secure element technologies implemented in various types of SIM cards and NFC chips, virtualized sandboxes, and the like. One skilled in the art and others will recognize that these are merely exemplary technologies that may be used to secure sensitive data and the examples provided herein should not be construed as limiting. In this regard, a more0detailed explanation of security agent technology suitable for use with the present disclosure may be found in the following commonly assigned, co-pending U.S. Patent Application No. 61895932, filed Oct. 25, 2013, entitled “MORE SECURE DEVICE ARCHITECTURE” which is hereby incorporated by reference. It should also be well understood that use of secure agent technology as described herein is preferred but not required in each embodiment of the present disclosure.

Exemplary components of a Security Agent 120 suitable for illustrating aspects of the present disclosure are further shown in FIG. 1. As depicted, the Security Agent 120 includes the Encryption Algorithm (EA) Key Logic 122, Signature Algorithm Index (SAI) Logic 124, the EA Table 126, and the Data Template 128. In a preferred embodiment, the Security Agent 120 implements at least some logic for managing access to sensitive data within the context of a hardware Encryption Engine 130 as described in further detail below. In one embodiment, there exists a plurality of encryption algorithms and hashing schemes that are shared and common to the transmitting and receiving devices 102-104. Upon initiation of a network communication, the Transmitting Device 102 generates an EA key set and communicates a corresponding EA public key to the Receiving Device 104. Upon receiving the EA public key, the Receiving Device 104 activates logic implemented in the Security Agent 120 to access the Data Template 128. In one embodiment, the Data Template 128 represents captured biometric data unique to a particular user, such as a fingerprint. While the present disclosure may use biometric data to define an encryption schema unique to a user, this should be construed as exemplary. In another embodiment, a derived signature that has features/data that are unique to a particular device which is known to be associated with a user is employed as the basis for the dynamic encryption scheme provided by the present disclosure. More generally, the Data Template 128 may be comprised of any type of data that is unique and can be associated with a specific user.

As mentioned previously, the Receiving Device 104 implements at least some logic for managing access to sensitive data (i.e. encryption data) in hardware. In one embodiment, the logic used to manage and exchange encryption data is implemented in a hardware-based Encryption Engine 130 as further depicted in FIG. 1. In this regard, the Encryption Engine 130 may be a component of a cryptographic processor or other circuit that implements the EA Key Logic 122, SAI Logic 124, and manages access to the lookup tables and data described herein.

The accessed Data Template 128 is analyzed on the Receiving Device 104 by the Security Agent 120. Based on the characteristics of the accessed data set, the SAI Logic 124 generates a Signature Algorithm Index (SAI). The Receiving Device 104 communicates the encrypted SAI to the Transmitting Device 102 which uses the received data to select certain variables of an overall encryption scheme. In this regard, FIG. 1 shows that the component architecture of the Transmitting Device 102 includes at least the EA Key Logic 132 and the EA Table 134. The attributes selected by the Transmitting Device 102 may involve variable time parameters that defines the time window in which a particular encryption algorithm will be employed in a communication session. In this regard, the Transmitting Device 102 can, at any point, issue a new EA key set and change the encryption algorithm. In this exemplary embodiment, the Transmitting Device 102 does not have the responsibility of selecting which encryption algorithm will be employed for the given time window. Instead, the Receiving Device 104 is responsible for selecting between the possible encryption algorithms. In this regard, the algorithm selected by the Receiving Device 104 can be any encryption algorithm, such as but not limited to RSA, Diffie-Hellman, the Data Encryption Standard (DES), the Digital Signature Algorithm (DSA), among others. The algorithm selected by the Receiving Device 104 may, and typically will, be based on features/data within the Data Template 128. Aspects of the present disclosure are directed to providing a framework for using any number of different encryption algorithms and dynamically modifying which encryption algorithms are employed in a communication session.

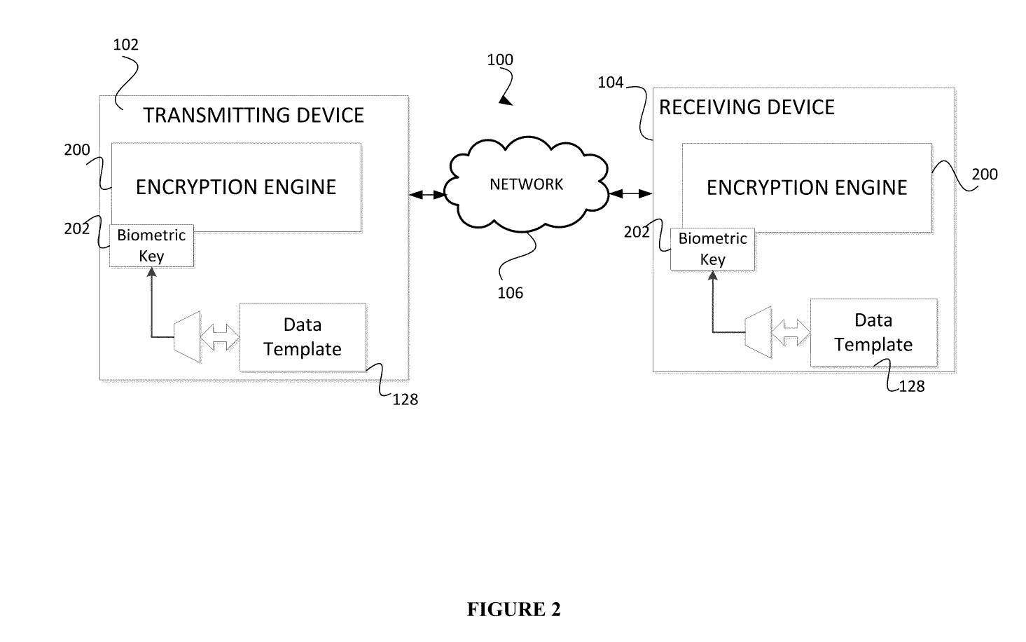

Now, with reference to FIG. 2, embodiments of the present disclosure in which the transmitting and receiving devices 102-104 are both in possession of data that is unique to a user (i.e. a biometric template) will be described. In the embodiment depicted in FIG. 2, the Transmitting Device 102 and the Receiving Device 104 both include an encryption engine 200. In this embodiment, data common, present, and known to both the receiving and transmitting devices 102-104 may be utilized to convey a public key without making the public key observable. Specifically, the Transmitting Device 102 and the Receiving Device 104 both include the Data Template 128 (FIG. 1), described above. In other embodiments described in further detail below, the public key may be hidden from any intervening observers through the use of an out-of-band communication channel. In either instance, the Receiving Device 104 may select a pointer into the Data Template 128. In some embodiments the Receiving Device 104 selects the pointer randomly using, for example a random number generator. In other embodiments, the pointer is identified by the Receiving Device 104 based on one or more features in a data set that is unique such as a biometric attribute of the user. Then, the pointer can be used to sample data from the Data Template 128 which is used to generate, in this example, the Biometric Key 202. As illustrated in FIG. 2, the Biometric Key 202 can serve the same or substantially similar function as the public key in an encryption algorithm (e.g. RSA, Chinese Remainder Algorithm, Diffie-Hellman, etc.) but is not made public. In this regard, the unique aspects of a biometric template that may be employed to generate the pointer include, but are not limited to, minutiae patterns, spectral attributes, ridge flow information, vein pattern, iris attributes, and the like.

One skilled in the art and others will recognize that the Networking Environment 100 depicted in FIGS. 1-2 provides a highly simplified example that merely illustrate the interactions between exemplary devices. In this regard, the functionality of the transmitting and receiving devices 102-104 described above may be implemented across devices or entirely in the same device. In other embodiments, certain functionality described with reference to FIGS. 1-2 can be implemented utilizing additional devices or other devices than those described above. By way of example, aspects of the present disclosure may be implemented in server-based computers and applications to facilitate interactions between endpoints. An authentication system flow is frequently implemented on server-based systems that provide a network service such as systems that provide virtual private networks, network-based authentication, SIP servers, eCommerce, VOIP telephony, media servers, and the like. The functionality described herein may be readily integrated into any network accessible device and implemented across any number of different devices and/or applications.

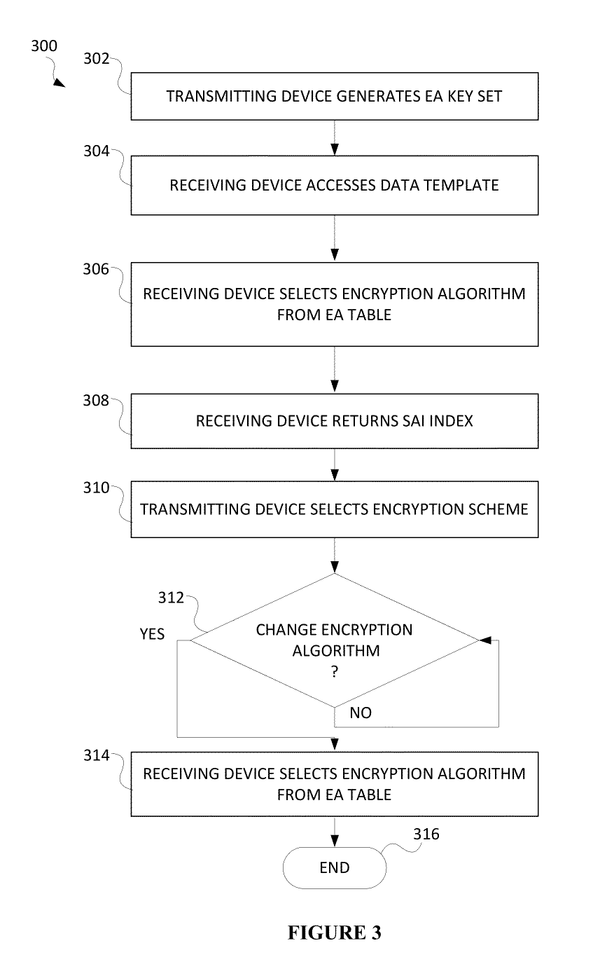

Now with reference to FIG. 3, a method 300 that enables registration between devices based an individual's identity will be described. For illustrative purposes, the method 300 is described in the context of the transmitting and receiving devices 102-104 and the various embodiments described above with reference to FIGS. 1-2. As an exemplary use case scenario of the method 300, a mobile device may be biometrically registered to a given user. Wireless discovery and communication with the registered mobile device could be restricted to only those connected devices that share the same biometrically-based encryption algorithm. As a result, communications could be restricted to only those devices that have performed a verified biometric authentication and employ the encryption schema that was selected using the same biometric data.

As illustrated in FIG. 3, the method 300 begins at block 302, where the Transmitting Device 102 generates an encryption algorithm (EA) key set and communicates a corresponding EA public key to the Receiving Device 104. Upon receiving the EA public key, the Receiving Device 104, activates logic to access the Data Template 128, at block 304.

In accordance with one embodiment, the Receiving Device 104 randomly selects an encryption algorithm from the EA table, at block 306. Then, the Receiving Device 104 returns an SAI to the Transmitting Device 102, at block 308. The SAI is then employed by the Transmitting Device 102, at block 310, to select the encryption scheme to be employed with regard to subsequent data encryption going forward. The encryption scheme selected by the Transmitting Device 102 may be employed for either a fixed or variable amount of time. Then, at decision block 312, a determination is made regarding whether to change which encryption algorithm is being used to encrypt data. In this regard and in accordance with one embodiment, the Transmitting Device 102 can, at any point, issue a new encryption algorithm key set to change encryption algorithms. The attributes regarding when to rotate between encryption algorithms are defined in the encryption scheme. In instances when the result of the test at decision block 312 is “YES”, the Receiving Device 104 then selects, at block 314, the encryption algorithm that will be employed for the subsequent window. This process of changing encryption algorithms continues until the communication session terminates at block 316.

The method 300 described with reference to FIG. 3 effectively implements a communication protocol that enables devices to be registered based on the biometric attributes of a particular user. This security protocol has a number of applications in securing network accessible data and cloud-based computing systems. By way of example, increasing amounts of data and information are being stored in cloud-based computing systems that are typically configured to provide various types of network services. A user's copy protected data may be sent between transmitting and receiving devices in a cloud-based system. Embedded in the copy protected data would be an encryption algorithm table that was generated using an authorized user's biometric template (as described above with reference to FIGS. 1-3). In this instance, the Security Agent 120 of the Receiving Device 104 would then be able to decrypt the copy protected data only for a specific user. The Receiving Device 104 would need the biometric data of the authorized user that produced the correct encryption algorithm table. This aspect of the present disclosure is applicable to protecting personal/business data maintained in the “cloud” including pictures, documents, movies, communications, etc. Increasingly, cloud-based services are being employed to store these types of sensitive data such as, but not limited to Apple's iCloud, Google Drive and related services, Amazon's Web Services, DropBox, and the like. By way of another example, aspects of the present disclosure may also be employed to enforce copyright protection. When a movie or other proprietary content is legally downloaded from the Transmitting Device 102, the data would be biometrically encrypted in a way that is specific to an individual consumer. In this instance, the Security Agent 120 of the Receiving Device 104 would then be able to decrypt the copy-protected data only for the purchaser associated with the download. Similar to the description provided above, any of the devices registered to the authorized user would need the biometric data of the authorized user that produces the correct encryption algorithm table.

It should be well understood that the depictions and descriptions provided with reference to FIG. 3 should be construed as exemplary. For example, the functionality depicted and in FIG. 3 is made in the context of a process flow diagram where steps are performed in a particular order. However, at least some of the steps can be performed in a different order and/or certain steps may be added/removed without departing from the scope of the claimed subject matter. Accordingly, the ordering and number of steps provided above with reference to FIG. 3 should also be construed as exemplary and not limiting.

Utilization of in-Band and Out-of-Band Communication Channels

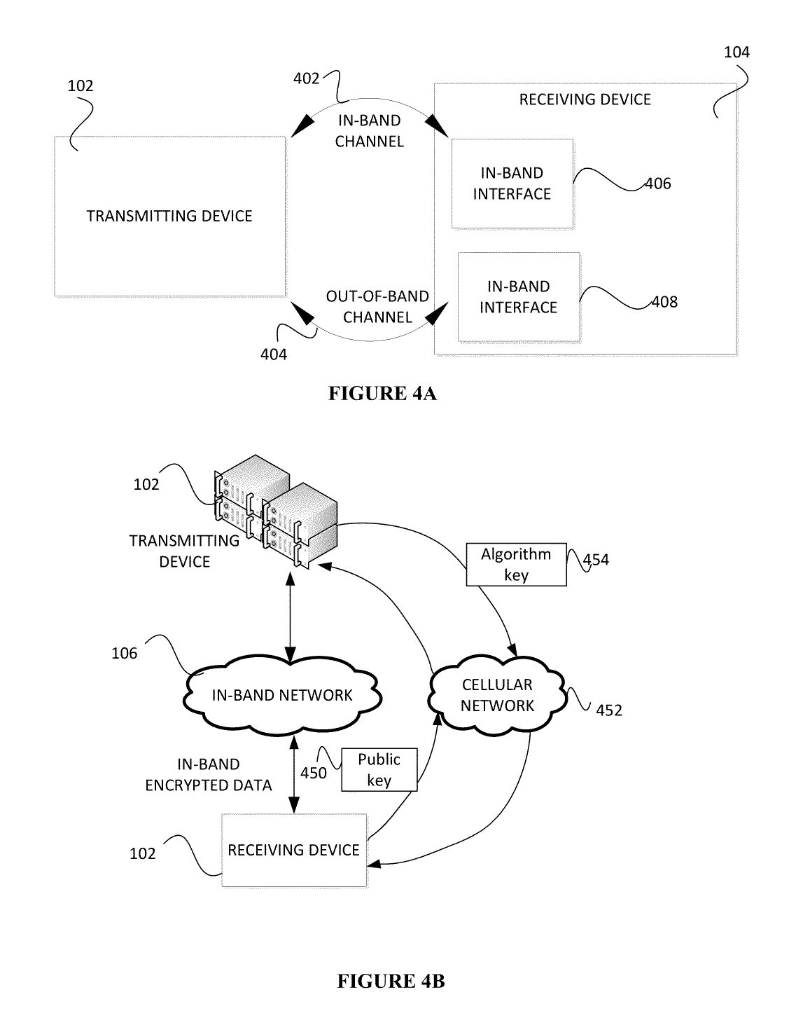

In one aspect, a key exchange protocol is provided that prevents intervening observers from accessing at least a public encryption key associated with a communication. At the initiation of any network communication and as illustrated in FIG. 4A, at least two distinct channels (i.e. the in-band and out-of-band communication channels 402-404) can be employed to separately communicate encryption keys. In accordance with one embodiment, the public key for in-band encryption is passed via the out-of-band channel 404. As further shown in FIG. 4A, the Receiving Device 104 includes both an in-band communication interface 406 and out-of-band communication interface 408 for separately communicating on the respective channels with the Transmitting Device 102. By way of example only, the in-band channel 402 that exists between devices typically flows through the Internet, but that is not required. In this regard, the in-band interface 406 will preferably be compatible with and utilize the appropriate technology for interacting with an existing authentication infrastructure. Accordingly, aspects of the present disclosure are able to further improve current encryption schemes like RSA by making encryption key variables non-observable through the use of out-of-band transmission technology.

In the exemplary embodiment illustrated in FIG. 4B, a Radio Frequency (RF) solution is employed that utilizes current cellular or other wireless protocols/technology to send SMS, UDDP, or similar structured message(s) to the Transmitting Device 102 via the cellular network 452. The message that is sent “out-of-band” in this way can include various security related data including the public key 450 that is used for data encryption in a communication session. As illustrated in FIG. 4B, this solution provides a means whereby the transmitting and receiving devices 102-104 are able to establish an encryption protocol where the public key 450 is not observable to any agents that snoop the in-band communication channel. While FIG. 4B depicts a Receiving Device 104 that transmits a security message out-of-band over the cellular network 452, the Receiving Device 104 may be configured to communicate “out-of-band” using one or any number of different protocols and wireless communication methods such as cellular, Wi-Fi, Bluetooth, Near Field Communications (NFC), and combinations thereof. Regardless of the communication method and in accordance with one embodiment, the present disclosure provides a secure method of completing out-of-band communications between the transmitting and receiving devices 102-104.

As further illustrated in the embodiment illustrated in FIG. 4B, the Transmitting Device 102 may also provide certain data to the Receiving Device 104 via an out-of-band channel. As described previously with reference to FIG. 1, the Transmitting Device 102 may generate an encryption algorithm key set and communicate a corresponding EA algorithm key 454 to the Receiving Device 104 over the cellular network 452. With the data exchanged in this setup process, the receiving and transmitting devices 102-104 are then able to participate in a communication session using the dynamic encryption schemes provided by the present disclosure. In the embodiment of the present disclosure visually depicted in FIG. 4B, the algorithm key 454 is transmitted from the Transmitting Device 102 to the Receiving Device 104 on an out-of-band communication channel as an SMS, UDDP, or similarly structured message. The exchange of data in this way provides additional security such that sensitive data is not visible to any observers on the in-band network 106. By utilizing distinct communication channels to separately transmit sensitive data as described herein, the present disclosure is able to eliminate threats posed by entire classes of malware and better-secure network communications.

### Biometric Encryption Algorithm Registration and Transmission

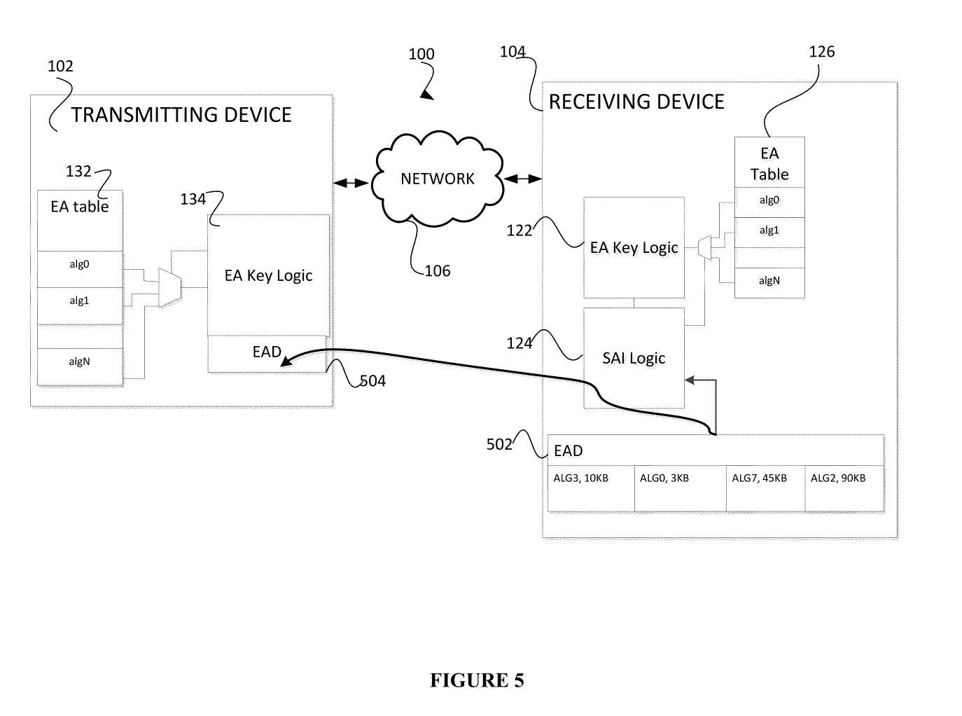

Now with reference to FIG. 5, additional embodiments of the present disclosure for establishing secure communications between devices will be described. In this regard, FIG. 5 illustrates the same transmitting and receiving devices 102-104 and their component architectures that were described with reference to FIG. 1, above. As mentioned previously, the Receiving Device 104 may provide the Transmitting Device 102 with the encryption algorithm data (EAD) once standard encryption (e.g. RSA) is established on an in-band communication channel. Alternatively, the EAD table 502 data may be transmitted on an out-of-band channel similar to the description provided above with reference to FIGS. 4A-B. In either instance, the encryption algorithm may be encoded as a series of index pointers into a SAI table that includes an optional duration/packet size field. Once the public key has been sent, the Receiving Device 104 reads the EAD table 502 and transmits its' contents to the Transmitting Device 102. Then, the Transmitting Device initializes it's EAD table 504 using the received data. As a result, the Transmitting Device 102 may then commence data transmission with the Receiving Device 104 using the dynamic encryption algorithm defined in the exchanged data. In the embodiment in which an out-of-band communication channel is available, the contents of the EAD table 502 may be transmitted via an out-of-band communication channel. This further improves security by making encryption algorithm data not observable by any observers on the in-band channel.

While the preferred embodiment of the present disclosure has been illustrated and described, it will be appreciated that various changes can be made therein without departing from the spirit and scope of the disclosed subject matter.

1. A device configured with an encryption engine circuit configured to perform a method for establishing a secure communication channel, the method comprising:
receiving a public encryption key from a transmitting device;
sending to the transmitting device an index referencing a table entry that identifies at least one variable in an encryption scheme;
encrypting data in a communication session with the transmitting device using a first encryption algorithm;
receiving an indicator to change encryption algorithms;
identifying a second encryption algorithm associated with the encryption scheme; and
encrypting data in the communication session with the transmitting device using the second encryption algorithm.
